(19) United States
(12) Patent Application Publication
(10) Pub. No.: US 2016/0078196 A1
(43) Pub. Date: Mar. 17, 2016

(54) SPECIMEN FULFILLMENT INFRASTRUCTURE

(71) Applicant: Novaseek Research LLC., Newton, MA (US)

(72) Inventors: Bennett Austin Malbon, JR., Newton, MA (US); Andrei Soran, Newton, MA (US); Ekaterina Vladimirovna Torchilin, Brookline, MA (US)

(73) Assignee: Novaseek Research LLC., Newton, MA (US)

(21) Appl. No.: 14/849,514

(22) Filed: Sep. 9, 2015

Related U.S. Application Data
(60) Provisional application No. 62/192,953, filed on Jul. 15, 2015.
(60) Provisional application No. 62/100,824, filed on Jan. 7, 2015.
(60) Provisional application No. 62/050,401, filed on Sep. 15, 2014.

(51) Int. Cl. G06F 19/00

(52) U.S. Cl. CPC G06F 19/363; G06F 19/322; G06F 19/321

(57) ABSTRACT

A computer system hosts a centralized data repository and a fulfillment platform. The centralized data repository receives clinical data corresponding to patients from multiple remote clinical data sources, aggregates the received clinical data, and normalizes the aggregated clinical data. The received clinical data may be pre-filtered based on patient consent. The fulfillment platform receives requests from requester computing devices, e.g., biological specimen requests or requests for prospective patients for a clinical study. The requests include cohort definitions. The fulfillment platform performs queries on the aggregated clinical data based on the requests, identifies matches in the aggregated clinical data in response to the queries, and transmits notifications to source site computing devices (e.g., dedicated tablet devices) for the identified matches. The notifications may identify, for example, matching biological specimens or prospective patients for clinical trials.

### CROSS-REFERENCES TO RELATED APPLICATIONS

This application claims the benefit of U.S. Provisional Application No. 62/050,401, filed Sep. 15, 2014, U.S. Provisional Application No. 62/100,824, filed Jan. 7, 2015, and U.S. Provisional Application No. 62/192,953, filed Jul. 15, 2015, the disclosures of which are incorporated herein by reference.

### BACKGROUND

Access to high-quality biological specimens and clinical data remains a major bottleneck in advancing medical research. Ongoing studies may face difficulties in obtaining needed biological specimens from which test data will be generated, and the scope of future studies may be limited due to a lack of appropriate biological specimens. There is currently no easy way for the research community to obtain information about biological specimens that may be stored in biobanks across the country, or that may be discarded in hospital laboratories.

In terms of human specimen procurement, the market is highly fragmented and largely consists of two types of players: “brick-and-mortar” biobanks and custom collection service providers. Biobanks store a wide array of specimen types including blood, plasma, and so on. A great deal of time and money is required to set up a biobank, establish a specimen library, and keep the enterprise operating. Custom collection service providers perform custom procurement of specimens. Typically, this type of service is labor and time intensive, making it difficult for researchers to estimate up front how long it will take and how much it will cost to acquire the specimens.

In addition, rich clinical data about patients often are not available, although such data is needed for discovery and development in the era of precision medicine. Identification of patients is one of the critical elements to advancing precision medicine—identifying the right patient at the right time for the right treatment. This is currently a very inefficient process and is a major cause of failure of clinical trials or identifying patients who qualify for research, as well as a barrier to overall improvement in healthcare efficiency while controlling costs. There is no easy way to identify such patients and alert relevant personnel once the appropriate patients are identified.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

In one aspect, a computer system hosts a centralized data repository and a fulfillment platform. The centralized data repository is configured to receive clinical data corresponding to a plurality of patients from a plurality of remote clinical data sources, aggregate the received clinical data, and normalize the aggregated clinical data. The received clinical data may be pre-filtered based on patient consent. The fulfillment platform is configured to receive a request from a requester computing device, e.g., a biological specimen request or a request for prospective patients for a clinical study. The request comprises a cohort definition. The fulfillment platform is further configured to perform a query on the aggregated clinical data based on the request, identify a match in the aggregated clinical data in response to the query, and transmit a notification to a source site computing device (e.g., a dedicated tablet device) for the identified matches. The notification may identify, for example, a matching biological specimen or a prospective patient for a clinical trial.

The fulfillment platform may provide a source site portal accessible by the source site computing device, and a requester portal accessible by the requester computing device. Matches may be identified based on a comparison of the cohort definition with a patient profile.

### BRIEF DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a system diagram depicting an illustrative embodiment of a computer system that provides a fulfillment infrastructure according to the present disclosure;

FIGS. 2-4 are screen shots of illustrative user interfaces provided by a requester portal in a fulfillment infrastructure according to the present disclosure;

FIGS. 5 and 6 are screen shots of illustrative user interfaces that provide fulfillment instructions on a source site computing device according to the present disclosure;

FIG. 7 is a screen shot of an illustrative user interface that provides a shipments view on a source site computing device according to the present disclosure;

FIG. 8 is a flow chart depicting an illustrative workflow for picking and shipping specimens at a hospital lab according to the present disclosure;

FIG. 9 is an illustration of a tablet device configured to receive notifications according to aspects of the present disclosure;

FIG. 10 is a flow chart illustrating a computer-implemented method according to an embodiment of the present disclosure; and

FIG. 11 is a block diagram illustrating aspects of an illustrative computing device appropriate for use in accordance with embodiments of the present disclosure.

### DETAILED DESCRIPTION

The present disclosure describes a novel infrastructure and related processes that provide technical solutions to technical problems, including particular solutions for automated, large-scale data collection, analysis, and search, and related, specialized electronic communications, which may be especially useful in the field of medical research. For example, the present disclosure describes a novel infrastructure for receiving and aggregating clinical data (e.g., patient data, biological specimen data, demographic data, etc.) from multiple remote data sources; receiving requests for, e.g., biological specimens or potential participants for clinical trials, identifying corresponding matches in the aggregated data, and providing automated, targeted notifications and logistics support when matches are identified. Described technical solutions allow researchers or other users to identify and obtain the large numbers of patients and/or biological specimens that may be needed to conduct effective research, clinical trials, and large-scale precision medicine, as well as great variety in patient demographics and medical conditions. Described technical solutions also provide ease of use for source sites (e.g., hospitals, ambulatory providers, biobanks, etc.) as notifications pushed to source sites reduce interruptions in terms of receiving phone calls from researchers, performing manual searches of specimen or patient records on request from researchers, etc.

The described infrastructure and related processes provide several potential benefits, including interoperability, with the ability to broadly integrate data collection across any electronic health records (EHR) or similar system; efficiency, with the use of a centralized data repository that aggregates data and stores data centrally rather requiring separate queries to individual hospital databases or other data sources; accuracy and trust in results, with the ability to normalize and analyze the centrally aggregated data and pre-filter data based on parameters such as patient consent, cohort criteria, etc.; usability, with the ability to automatically translate between terms used by non-medical personnel, such as researchers, and entities that generate the data they need, such as hospitals; and real-time or near real-time functionality, with the ability to send notifications to personnel as soon as a potential match is identified, as well as the ability to send feedback to the requester as the request is being formulated.

In the following description, numerous specific details are set forth in order to provide a thorough understanding of illustrative embodiments of the present disclosure. It will be apparent to one skilled in the art, however, that many embodiments of the present disclosure may be practiced without some or all of the specific details. In some instances, well-known process steps have not been described in detail in order not to unnecessarily obscure various aspects of the present disclosure. Further, it will be appreciated that embodiments of the present disclosure may employ any combination of features described herein. The illustrative examples provided herein are not intended to be exhaustive or to limit the claimed subject matter to the precise forms disclosed.

For ease of discussion and illustration, the present disclosure uses terms such as “analyze,” “normalize,” “aggregate,” and “query” as high-level terms for operations performed by a computer, and should not be confused with acts performed by a human being unless explicitly stated otherwise. The lower-level computer operations corresponding to these terms may vary depending on, for example, the type of computing device and operating system being used, software or hardware design considerations, and/or other factors.

The present disclosure includes several novel aspects. In one aspect, a fulfillment infrastructure is designed to automate matching of orders of researchers to available specimens and fulfill the orders. The fulfillment infrastructure includes computing hardware on which a requester portal executes, which may include, for example, a web front end where researchers or other requesters place the orders and interact with an analytics system; computing hardware on which a source site portal executes, which may include, for example, a web front end where lab technicians or other personnel receive and process the orders; and computing hardware on which a centralized data repository of historical and current data and a fulfillment platform are hosted. The fulfillment infrastructure also may include computing hardware on which an integration application is executed, which receives regular data updates on available specimens or patients from hospitals, clinics, labs, or other data sources. Potential users of the fulfillment infrastructure include pharmaceutical and biotechnology companies, diagnostic development companies, academic institutions, and clinical research organizations.

The fulfillment infrastructure is flexible and adaptable to evolving research needs. The fulfillment infrastructure provides many potential benefits, including, but not limited to greater availability of biological specimens that are richly annotated with patient clinical information; analytics to drive improved project design and feasibility analysis; single-point search; and, where pricing information is provided with search results, price transparency.

The fulfillment infrastructure acts as an intermediary between requesters (e.g., researchers) and source sites (e.g., hospitals and biobanks) and may potentially be used at several stages of a research process, including, without limitation, project planning and budgeting, sales quotes, and placing and changing orders. The fulfillment infrastructure may serve more than one purpose. As examples, the fulfillment infrastructure may be used in matching researchers' requests for specimens in hospital or clinical laboratories or third-party biobanks, for patients as potential candidates for clinical studies, or other requests.

Regarding specimen fulfillment, the infrastructure may be used to source biological specimens and data for biomedical researchers. (The term “biological specimens,” as used herein, may refer to human, animal, or other biological specimens, as may be appropriate for the type of study being performed.) There are several types of biological specimens: blood and blood components (e.g., serum, plasma), urine, tissue from biopsy or surgery, swabs, and so on. Such specimens are usually kept in a laboratory for a period of time after testing. During this period, specimens can be compared against requests from researchers, and the specimens that have been requested by researchers can be shipped to them.

In an illustrative specimen fulfillment scenario, a list of available specimens and corresponding clinical data is uploaded at least daily from each participating source site (e.g., in the form of EHR data associated with patients that have provided opt-in consent). Researchers use a search engine to find and select coded specimens and submit requests online. Specimen requests are matched against specimens in the centralized data repository. If a match is identified, the lab is notified. A bar code label can be generated with a new, random identifier. The label can be affixed to a tube or other suitable container to which the specimen is transferred, and the specimens can be packed and shipped directly to the researcher by the laboratory.

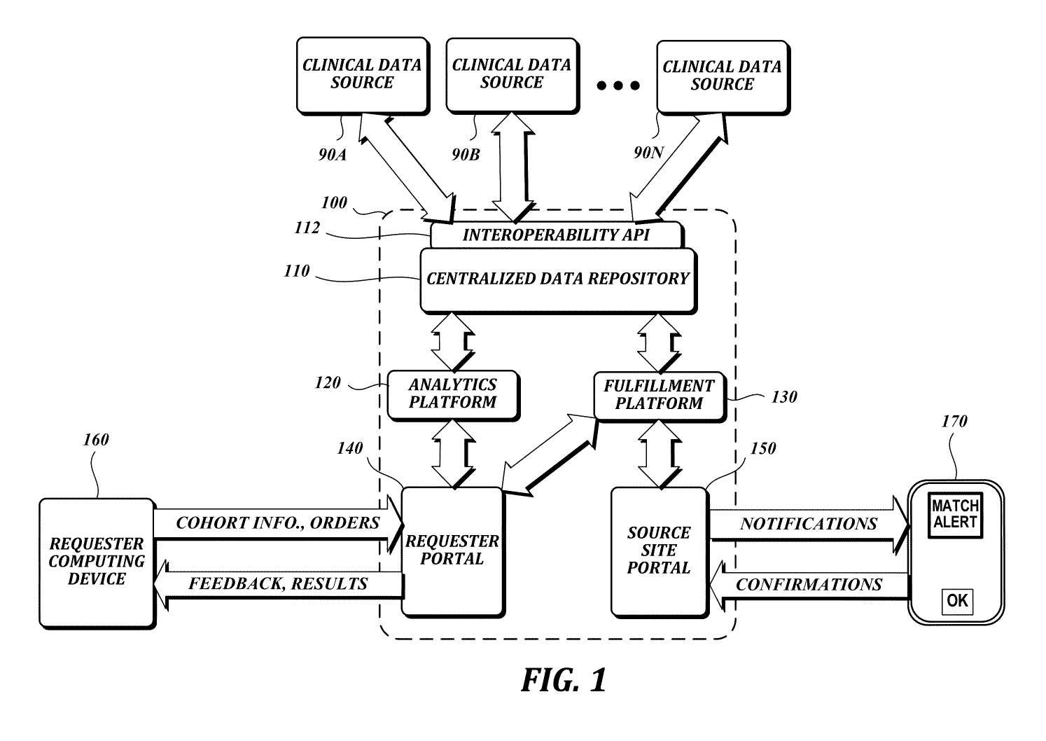

FIG. 1 is a system diagram depicting an illustrative embodiment of a computer system that provides a fulfillment infrastructure according to the present disclosure. In the example shown in FIG. 1, a computer system 100 hosts a centralized data repository 110 that receives clinical data from several clinical data sources 90A-90N via a network (not shown), such as the Internet. The centralized data repository 110 exposes, in this example, an interoperability API (application programming interface) 112 that allows the various data sources 90A-90N to provide the clinical data without requiring burdensome modifications of the clinical data at the data sources. The centralized data repository 110 improves upon a federated approach in which multiple data sources must be separately queried.

The clinical data may be available electronically in a variety of data formats, and may include forms that comply with HL7® standards (promulgated by Health Level Seven International), flat file documents, or continuity of care documents (CCDs). Data integrations can be tailored to take input data from each source site. An integration platform (not shown) can be used to standardize the data format and normalize all coded data (e.g., to common dictionaries), and prepare the data for further processing. Data can be encrypted for security purposes. For example, data can be encrypted in transit between the clinical data sources 90A-90N and the centralized data repository 110 via a virtual private network (VPN) with restricted port-specific access.

The clinical data includes information that may be useful for finding matches for requests, which may include information such as demographics (e.g., age, sex, race, ethnicity, geography), comorbidities (e.g., chronic and current conditions, when diagnosed); medications (e.g., type, frequency of dose, dosage amount, route, when prescribed); procedures (e.g., type, when performed); lab results (e.g., type of test, value, when tested); physician information (e.g., referring, admitting, and/or consulting physicians); and any other information that may be available or become available in hospitals and may be needed or useful for finding matches for requests. The clinical data may include coded information, structured information, or unstructured information, which may exist as free text, notes, or the like.

For requests for potential clinical trial subjects or precision medicine patients, such information may be associated with a patient profile, which may be coded to preserve patient privacy. For specimen requests, such information also may be associated with a specimen identifier along with other specimen information (e.g., specimen type, date, etc.), along with a patient profile. Illustrative matching processes are described below.

The clinical data sources 90A-90N may be associated with one or more source sites (e.g., hospitals, ambulatory providers, or biobanks). The clinical data sources 90A-90N may include repositories that employ specialized information management systems, such as LIMS (laboratory information management systems). A single source site may provide one or more of the clinical data sources 90A-90N from within its facility or organization.

Source sites may obtain consent and authorization from patients, e.g., in the form of signed consent and authorization forms, which may be approved by an institutional review board (IRB). Consents and patient data may be collected prospectively, e.g., before actual specimens are obtained, at the point of admission or registration. Consent status can be captured electronically for each patient (e.g., by scanning a paper form, extracting status from a web-based form, etc.). Consent status can then be used to filter data sent by a source site to the centralized data repository 110 to ensure that only data from patients who have explicitly granted consent and authorization to participate is received.

In the example shown in FIG. 1, the computer system 100 also hosts an analytics platform 120 and a fulfillment platform 130. The computer system also provides a requester portal 140 that interacts with the analytics platform 120 and the fulfillment platform 130, and a source site portal 150 that interacts with the fulfillment platform 130. Access to the various functionality of the requester portal 140 and the source site portal 150 can be provided, for example, by web browsers or dedicated applications running on requester computing devices or source site computing devices.

As shown in FIG. 1, a requester computing device 160 interacts with the computer system 100 via the requester portal 140. A requester computing device 160 is a computing device of any suitable configuration or form factor, such as a desktop computer, notebook computer, tablet computer, or smart phone. In an illustrative embodiment, a user (e.g., a researcher) of the requester computing device 160 interacts with the requester portal 140 via a web browser that provides a user interface through which the user can make requests for biological specimens, patients for participation in clinical trials, or the like, as described in further detail below. Although only one requester computing device 160 is shown for ease of illustration, it should be understood that more than one, and potentially hundreds or thousands of requester computing devices may be accommodated.

At a basic level, the requester portal 140 provides an interface between requester computing devices and the computer system 100. However, the requester portal 140 may provide many other features in addition to this basic functionality.

For example, in one embodiment, the requester portal 140 includes several sections, including analytics, orders, and account management or administrator sections. These sections are only examples, and the actual number of sections and functionality of specific sections may vary depending on implementation. The analytics section of the requester portal 140 may provide access to the analytics platform 120, which provides researchers with tools to predict availability and accrual rate of desired samples and cohorts. The analytics platform 120 also can give researchers insight into feasibility and an expected timeline as they are creating orders. For additional details on illustrative features and uses of the analytics platform, see U.S. patent application No. XX/YYY,ZZZ, entitled “Specimen Fulfillment Analytics and Procurement Process,” filed concurrently herewith, which is incorporated herein by reference.

The account management or administrator section provides settings for user information, passwords and security questions, and generic shipping instructions. This section also may include features to allow administrators to track (e.g., at an enterprise level) submission and approval of project proposals, view current and past projects, track user activity, etc. The source site portal 150 also may include contain account management or administrator features similar to the requester portal 140.

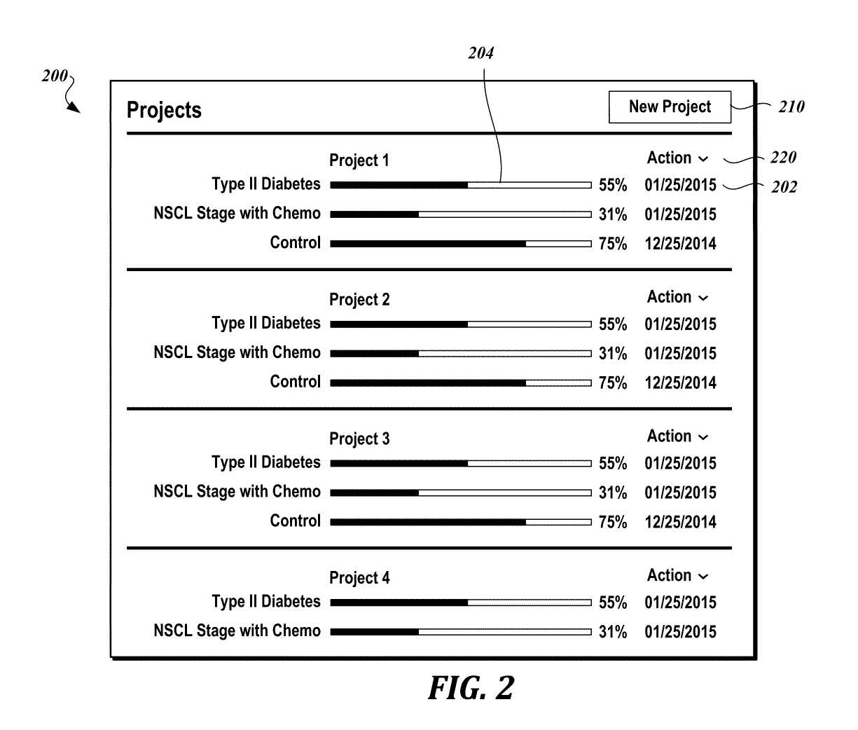

FIG. 2 is a screen shot of an illustrative user interface 200 for an account management or administrator section provided by a requester portal and presented in a “Projects” view. As shown, the projects view lists status of projects (including, e.g., progress bars 204, percentages of specimens collected, projected completion dates 202, etc.). This view may be updated as progress is made on a project (e.g., by updating percentages and projected completion dates, replacing a projected completion date with text such as “completed” to indicate a change in project status, etc.). This view may consolidate activities for one or more users that are working on the respective project. For example, this view may add numbers of specimens obtained through orders placed by multiple users, and compare that subtotal against the total that is needed for the project (e.g., as a percentage). The user interface 200 may include interactive elements, such as the new project button 210, which may be tapped, clicked, or otherwise activated to open a new project, and the action menu 220, which may be a drop-down menu with available actions to be taken, such as reviewing details of projects, confirming completion or changes to projects, or approval of proposed projects. Other views not shown in FIG. 2, such as a detailed user activity view, an administrator settings view, etc., also are possible.

The orders section allows researchers to create new orders. For example, a researcher can create a new order for specimens by identifying specimen type and cohort information (e.g., demographics, comorbidities, prescription medications, and procedures). Orders can be filled as they become available from source sites. Researchers can manage orders in progress. To this end, the orders section may include options to moderate matched specimens prior to shipping, and to update or cancel orders.

If multiple requests are received for the same specimen, the fulfillment platform can establish who gets the specimen first (e.g., based on which order was placed first), and potentially direct other orders to a different source site, such as a particular hospital that is known to have similar specimens. Source sites may be permitted in some circumstances to review specimen orders and decide if they do not want to ship them, such as where specimens may be needed internally at the source site.

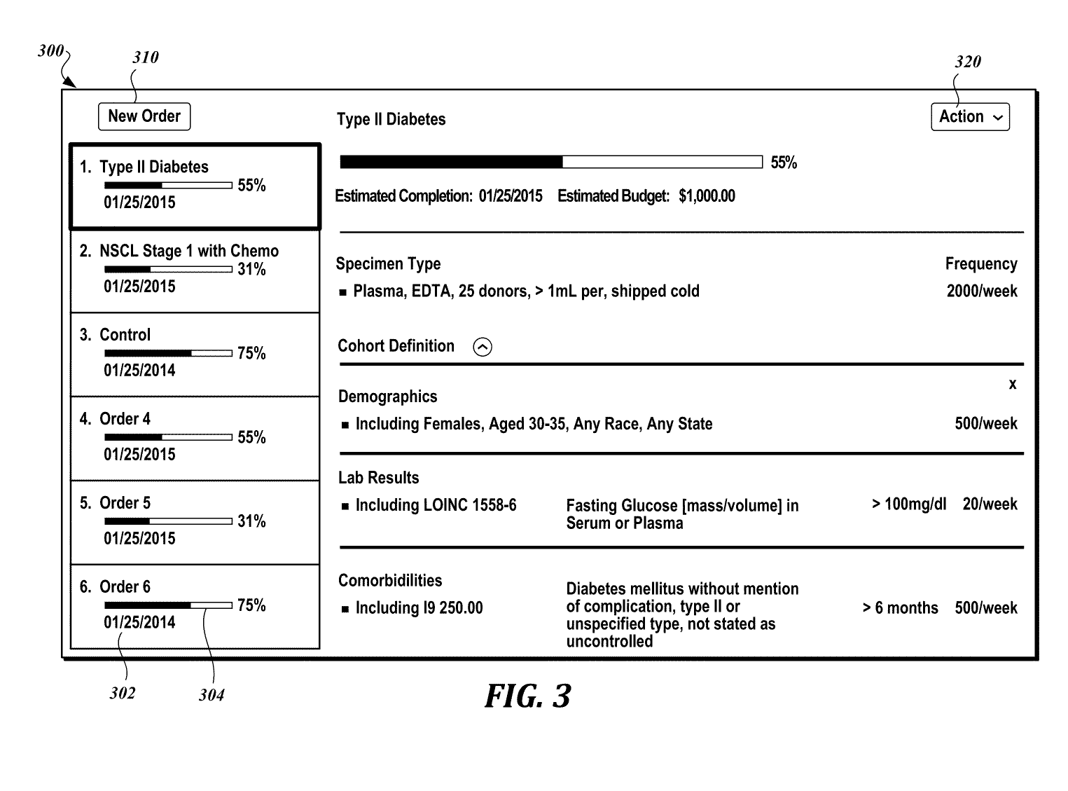

FIG. 3 is a screen shot of an illustrative user interface 300 for an orders section. As shown, the user interface 300 lists orders with respective status information (including, e.g., progress bars 304, percentages of specimens collected, projected completion dates 302, etc.). This view may be updated as progress is made on an order (e.g., by updating percentages and projected completion dates, replacing a projected completion date with text such as “completed” to indicate a change in order status, etc.). This view may include orders for a single user, or, for a user such as a manager or an administrator, multiple users. The user interface 300 may include interactive elements, such as the new order button 310, which may be tapped, clicked, or otherwise activated to open a new order. The user interface 300 also may be used to edit orders, set criteria (e.g., cohort definitions) for new orders, etc. The action menu 320 may be a drop-down menu with available actions to be taken, such as reviewing details of orders, editing orders, or canceling orders.

In the user interface 300, feedback is provided to illustrate how particular aspects of an order may affect rates of completion of the order. In the example, shown in FIG. 3, frequencies are shown for the specimen type (e.g., 2000 plasma samples per week), demographics (e.g., 500 females of a particular age group per week), lab results for a particular test, and comorbidities. The user interface 300 also may present a combined frequency for samples that meet all of required criteria (e.g., a frequency that is no higher than the lowest frequency for any individual required criteria), and adjust the estimated completion date accordingly. The user interface 300 also may present a cost estimate based on required criteria and number of samples needed, and potentially other factors. Estimated completion dates and costs can be adjusted dynamically, e.g., as criteria are set and adjusted when a user is creating a new order, which can help to guide users in creating orders that are feasible and appropriate for a particular project.

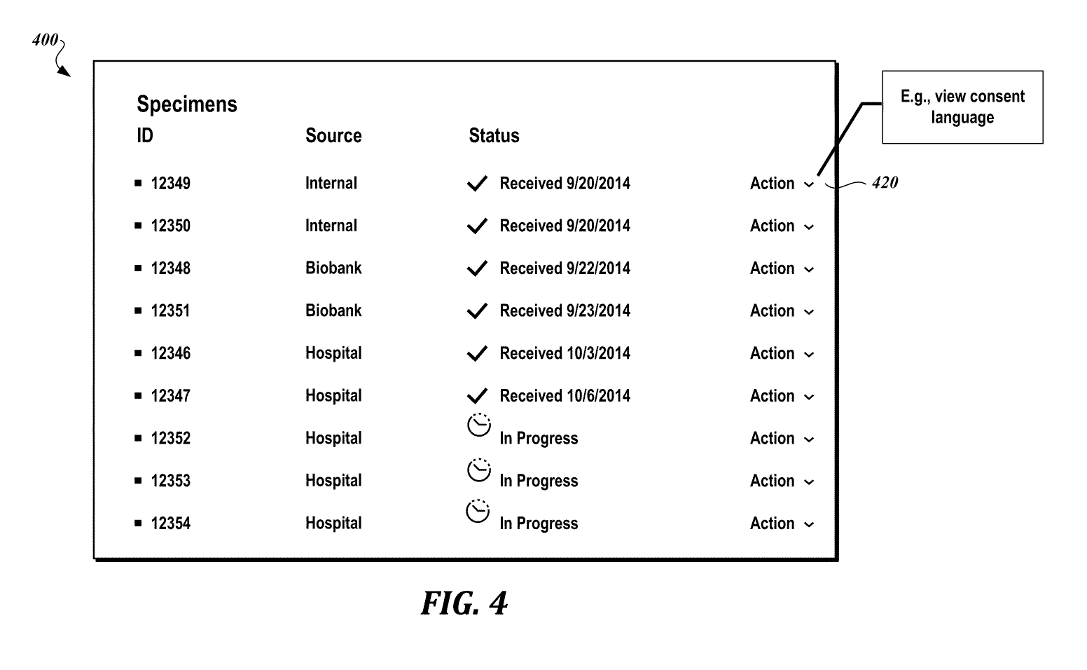

The requester portal also may provide relevant information that may be useful for tracking specific specimens, information about patient consent, such as applicable consent language for each specimen, and other relevant information. FIG. 4 is a screen shot of a specimens view in an illustrative user interface 400 that may be presented, for example, in an orders section or an administrator section of a requester portal. As shown, the user interface 400 provides information for a list of particular specimens that have been ordered, such as specimen IDs, source, and status (e.g., a date of receipt). This view may be updated as progress is made on an order (e.g., by updating the status of particular specimens). The user interface 400 includes interactive elements, such as the action menu 420, which may be used to select actions for a specimen, such as viewing additional details (e.g., consent language associated with a particular specimen). Such information may be useful to allow personnel to check if a patient (identified by an anonymous patient ID) has consented to being contacted (e.g., for possible participation in a clinical trial) before reaching out to the patient.

Referring again to FIG. 1, a source site computing device 170 interacts with the computer system 100 via the source site portal 150. A source site computing device 170 may be a computing device of any suitable configuration or form factor, such as a desktop computer, notebook computer, tablet computer, or smart phone.

In an illustrative embodiment, a user (e.g., a lab technician) of the source site computing device 170 interacts with the source site portal 150 via a web browser that provides a user interface through which the user can receive notifications of potential matches for requests for biological specimens, patients for participation in clinical trials, or the like, as described in further detail below. Preferably, the source site computing device 170 is a tablet computer or other mobile computing device that can be easily carried by a lab technician or other personnel that may respond to such notifications. The source site computing device 170 receives a notification (e.g., via fax, email, instant message, SMS, push notification, etc.) when there is an actionable match.

Although only one source site computing device 170 is shown for ease of illustration, it should be understood that more than one, and potentially hundreds or thousands of source site computing devices may be accommodated. The source site computing device 170 can be a dedicated device that is specifically programmed to only allow access to the source site portal 150 and related functionality. A dedicated device may be, for example, a special-purpose device that lacks some functionality that may ordinarily be present on a general-purpose computing device, or a general-purpose device with other functionality (e.g., general Internet access) included but disabled. As an example, a special-purpose device may provide notifications and access to the source site portal 150 via a dedicated software application or specially modified web browser, rather than a general-purpose web browser.

At a basic level, the source site portal 150 provides an interface between source site computing devices and the computer system 100. However, the source site portal 150 may provide many other features in addition to this basic functionality. For example, in one embodiment, the source site portal 150 transmits a notification to one or more source site computing devices 170 associated with a source site when there is a matching specimen identified in their facility. For example, referring to the source site computing device 170 shown in FIG. 1, a user may click or tap a “Match Alert” notification to obtain additional information about the match, and confirm receipt of the notification by clicking or tapping on the “OK” button, which may generate a confirmation to be transmitted back to the computer system 100. Further information on illustrative notifications and related processes is provided below.

Upon receiving the notification, a user of the source site computing device 170, such as a lab coordinator, is alerted to the match and may check the portal for additional details, such as which specimens match an order. Information that may be used to identify the specimen may include a patient identifier (such as a name or an anonymous identifier), visit information, and a specimen identifier.

Once the matching specimen is identified, the specimen can be provided to the requester by any suitable means. In one illustrative scenario, a lab coordinator or technician obtains the matching specimen and transfers it to a pre-labeled and de-identified container (e.g., a tube or other suitable container) stocked in the lab. The container can then be scanned or photographed (e.g., with a tablet computer having a digital camera) to obtain a digital image of the anonymized/bar-coded container. The image, code, and other identifying information can then be associated with the order. An estimated residual amount can be entered, and the specimen can be packed for shipping by any suitable method. The source site portal may provide specialized functionality associated with shipping specimens, such as the ability to print a shipping label, correlate shipment tracking information to the specimen, view real-time tracking information (e.g., in coordination with a courier's shipment tracking API). The requester portal 140 also may provide shipment tracking information and order status information to requesters.

Many alternatives to the arrangement depicted in FIG. 1 are possible. For example, a computer system dedicated to analytics may host the analytics platform 120, but not the fulfillment platform 130, which may be hosted by a different computer system. As another example, some functionality that is described as being provided by the computer system 100, such as functionality associated with the requester portal 140, may instead be provided directly by software installed on a suitably programmed requester device. As another example, in the arrangement shown in FIG. 1, the source site portal 150 provides access to the fulfillment platform 130, but not the analytics platform 120. However, alternative designs are possible in which the source site portal 150 provides access to the analytics platform 120. For example, it may be desirable to allow source sites to use the analytics platform 120 to determine, for example, whether there is a surplus or shortage to which they may be able to respond by decreasing or increasing efforts, respectively, to obtain corresponding specimens.

Illustrative Matching Process

In this example, researcher users define cohorts articulating clinical attributes of patients they hope to find, e.g., for specimen procurement, clinical trials, or other purposes. Cohorts include inclusion or exclusion criteria, such as demographics, specimen type, disease states, lab results, medications, and/or procedures. Referring again to FIG. 1, once a researcher has activated a cohort in the requester portal 140, the computer system 100 looks for matching clinical records in the centralized data repository 110.

In this example, the centralized data repository 110 receives continuously updated patient information in near real time. Matches are determined based on fit between a patient's clinical data and the cohort. Once a request has been submitted, the computer system 100 can automatically (e.g., on a daily basis or at some other time interval) query the centralized data repository 110 based on the original request (or, if any updates have been made to the request, the updated request) to determine if any patients match the active cohorts. When a match is found, a communication and logistics process is triggered.

In this example, a patient is determined to be a match for a cohort if the relevant values in the patient's clinical data are equal to the values (if specific values are specified) or within the corresponding ranges (if ranges are specified) required by the cohort definition. For instance, a 50-year-old male patient with type 2 diabetes admitted to acute care for congestive heart failure can be designated as a match for a cohort of 45-55-year-old males with type 2 diabetes, while a 50-year old female patient would not be designated as a match.

Illustrative Notifications and Logistics

In this example, a source site (e.g., a hospital or ambulatory provider) is notified to take follow-up action when a patient matches a cohort. Follow-up action at the source site may include sending a specific specimen to a researcher, or contacting the patient to enroll in a clinical trial. A source site computing device (see FIG. 1), such as a pre-configured tablet device, is provided to each participating source site. This device provides lists of matching patients and instructs the user to take specific follow-up action. In the case of specimen procurement, the source site user is instructed to de-identify the specimen, pack it into a send out kit, print a manifest and shipping label from the tablet, and send the specimen to the researcher who requested it.

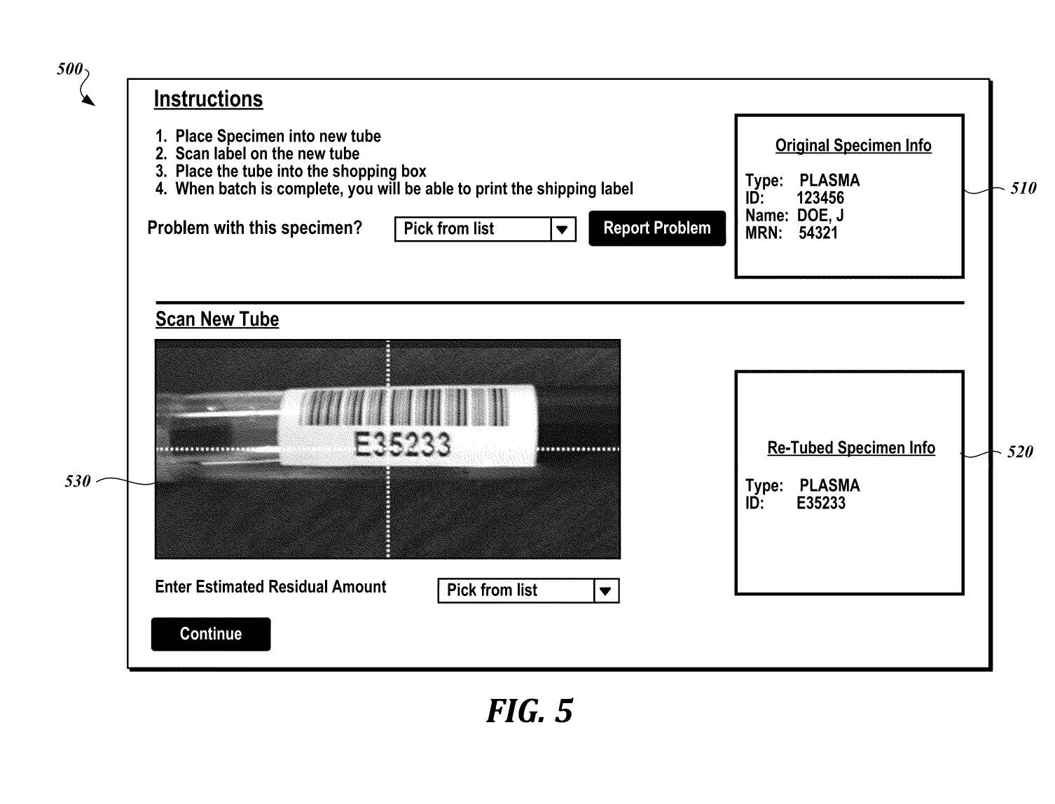

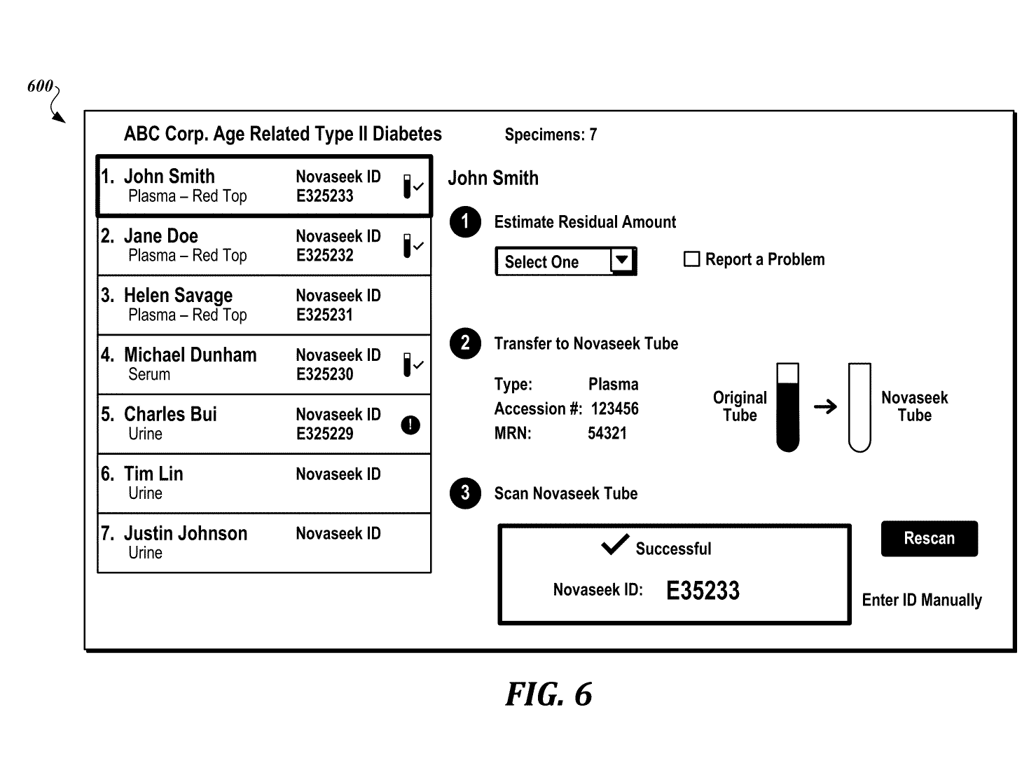

FIGS. 5 and 6 are screen shots of illustrative user interfaces for shipping matched specimens. In the example shown in FIG. 5, the user interface 500 provides instructions for personnel that may be tasked with shipping matched specimens, information 510 on the original specimen, de-identified specimen information 520, interactive elements for reporting problems with a specimen and estimating residual amounts, and a viewfinder window 530 to facilitate capturing a digital image of the bar code. FIG. 6 is a screen shot of another user interface 600 listing details of specimens to be shipped, and instructions for estimating residual amounts, reporting problems with specimens, transferring specimens to de-identified containers, and scanning the containers, along with interactive elements for estimating residual amounts and scanning containers.

Bar coded tubes can be provided in advance to source sites in order to streamline the de-identification process. The bar code may encode any suitable identifier. In at least one embodiment, the identifier is a randomized, unique 5-digit string generated from a 29 character alpha-numeric alphabet. The alphabet may exclude certain characters, such as vowels and the numbers 0 and 1, to prevent undesirable codes, such as words or near words, from being generated.

When a specimen is matched, the source site user (e.g., a lab technician) can be instructed (e.g., automatically, by the source site computing device 170) to pick the original specimen and re-tube it into an anonymized tube, or otherwise place the specimen, or a portion of it, into an anonymized container. The bar-coded, anonymized container can be scanned (e.g., by the source site computing device 170) to associate the new specimen code, with the original record. This association can be stored in the centralized data repository 110. The tube can then be shipped directly to the requester. In this way, a specimen can be provided to the requester while still protecting patient privacy and confidentiality, in compliance with HIPAA and OHRP standards.

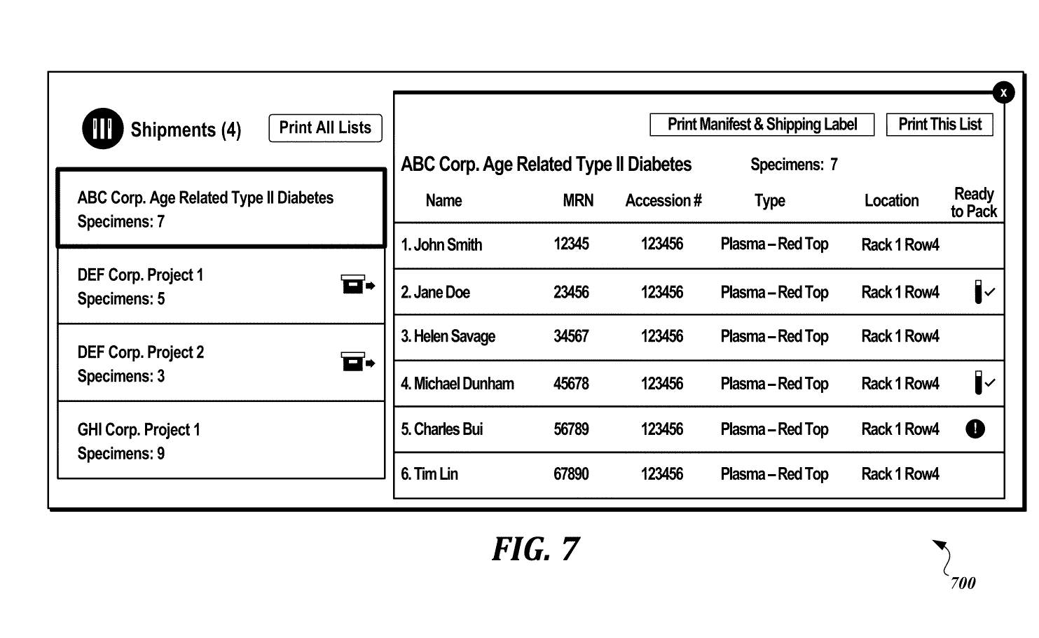

FIG. 7 is a screen shot of an illustrative user interface 700 that provides a shipments view, allowing lists of specimens to be shipped to viewed along with details of the particular projects to which they relate, status information (e.g., icons indicating whether the specimens are ready to pack for shipping), and interactive elements, such as buttons for printing manifests and shipping labels, printing lists, etc.

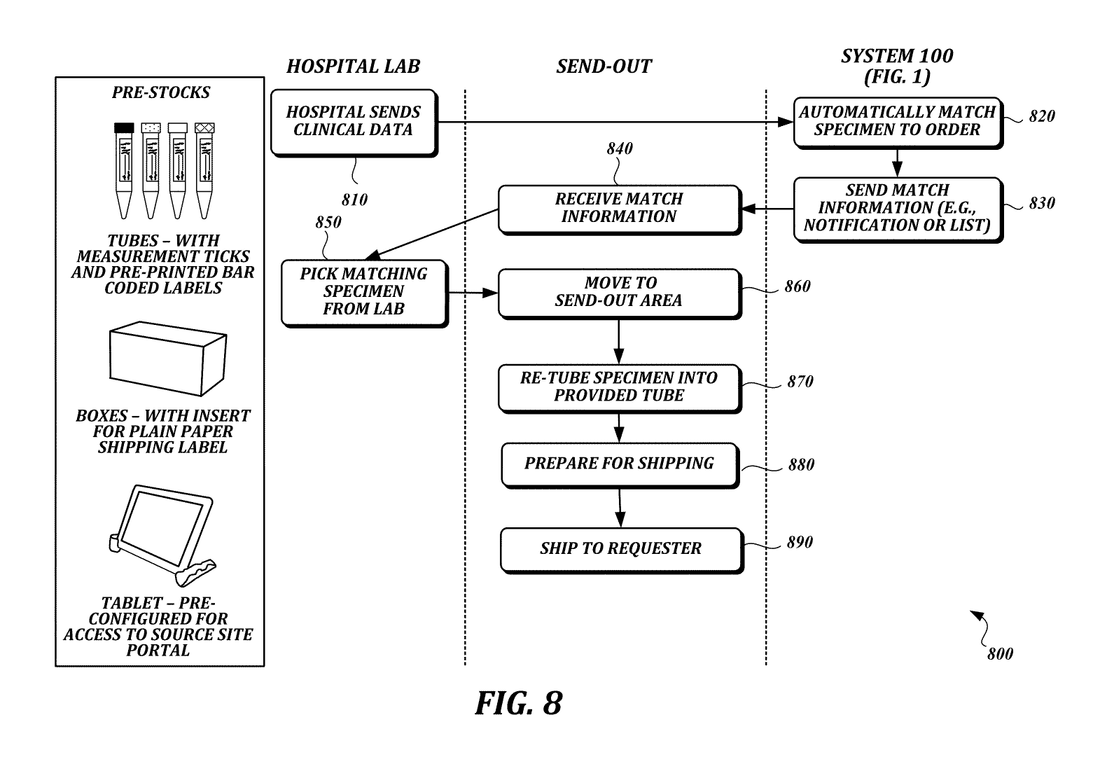

FIG. 8 is a flow chart depicting an illustrative workflow 800 for picking and shipping specimens at a hospital lab that communicates with the computer system 100 shown in FIG. 1. In the example shown in FIG. 8, the hospital lab acts as both a direct data source for the computer system 100 and a source site. However, this is not required. For example, it is possible for a hospital lab to upload its data to a third party, such as a cloud storage facility, which may then provide the data to the computer system 100. In such a scenario, the computer system 100 obtains the data from the third party, rather than directly from the hospital lab. However, notifications need not be transmitted to the third party, but may instead be transmitted directly to the source site.

According to the workflow 800, the hospital lab sends clinical data, such as HL7 data, to the computer system 100 at step 810. The computer system 100 then matches a specimen to an order at step 820 and sends match information (e.g., in the form of notifications or a daily list) to the lab at step 830. As shown, the lab has a designated “send-out” area in which lab technicians receive the match information at step 840 and prepare specimens for shipping. For example, lab technicians using dedicated tablet devices may receive notifications via the tablet devices, receive fulfillment instructions via the tablet devices, and prepare the specimens for shipping using the tablet devices, as described in illustrative detail herein. The specimens themselves may be picked from the lab at step 850 and moved to the send-out area at step 860, after which they are re-tubed at step 870, prepared for shipping at step 880, and shipped to the requester at step 890.

The illustrative workflow 800 has several possible advantages. For example, it fits seamlessly into a laboratory workflow (e.g., no extra bench space required, no integration needed with hardware/software in the lab) and it increases the quality control over the process and overall process up-time (no integration with other hardware such as fax, bar code scanners, etc.). As another example, lab technicians get information about a specimen pick list from one dedicated screen (e.g., on the source site computing device 170), to reduce the risk of missing an email, fax, or another, less precisely targeted communication. The source site computing device 170 can be used as a scanner at step 880 to scan the new barcode label after the specimen is re-tubed, thereby reducing the chances of sending specimens with incorrect specimen information or inadvertently releasing patient identifiable data, while also eliminating the need for additional, specialized scanning equipment. (See, e.g., the user interface 500 described above with reference to FIG. 5.) Also, the workflow 800 may facilitate tracking of residual amounts of specimens (i.e., how much specimen is left after testing in the lab) at step 880 by providing pre-stocked tubes having tick marks for estimating residual volume during re-tubing and by prompting the lab technician to enter this information into the source site computing device 170. (See, e.g., the user interface 600 described above with reference to FIG. 6.)

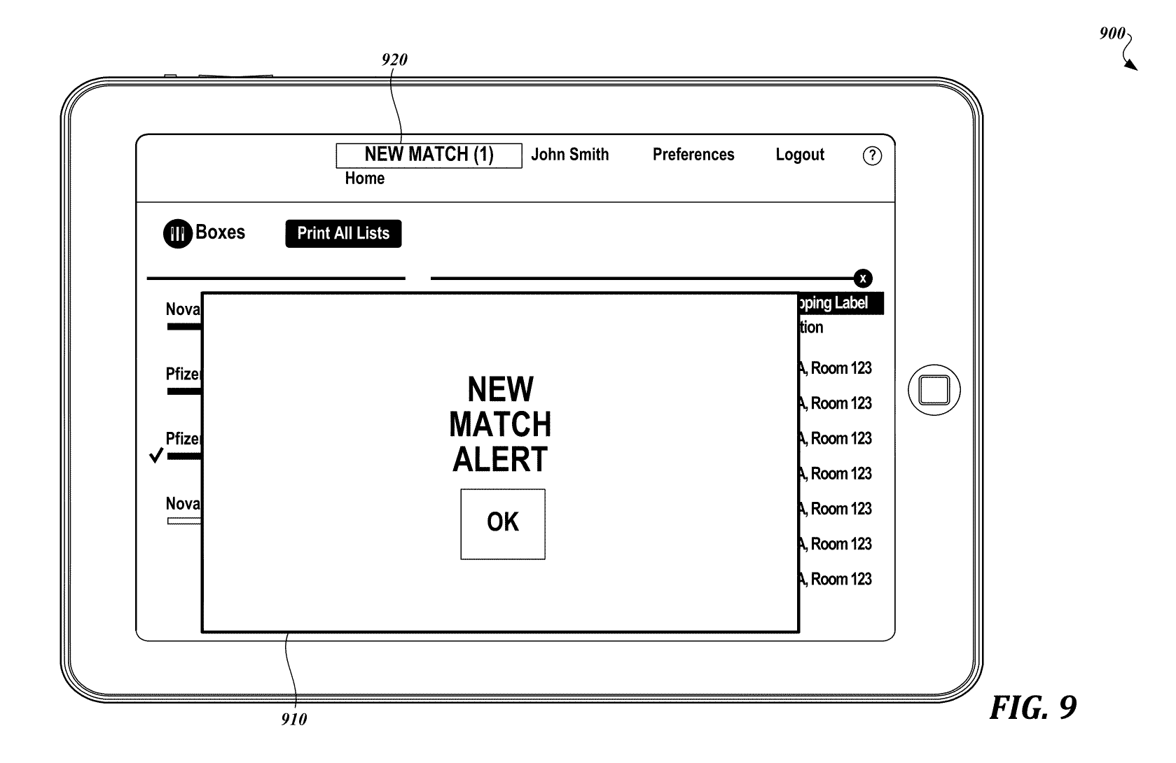

FIG. 9 is an illustration of a tablet device 900 configured to receive notifications according to aspects of the present disclosure. In the example shown in FIG. 9, a notification 910 is provided in the form of a window indicating that a new match has been found. In this example, the notification 910 prominently and temporarily obscures other content on the screen of the device until the notification is dismissed (e.g., by tapping the “OK” button). The notification 910 is supplemented in this example with a smaller notification 920 at the top of the user interface. The notification 920 provides the ability to continue to remind the user of the match, even after the larger notification 910 is dismissed. This allows the user to continue working on an important task, such as completing a shipment, without losing all indications of the new alert when the notification 910 is dismissed.

Matches also can be indicated by, e.g., a flashing light or graphic, a special icon or animation, or any other suitable indicator. A user interface element that can be activated by the user may also be provided to allow the user to access details of the alert. The alert may display, for example, a list of patients to be contacted or specimens to be fetched because they match the user request (e.g., by matching all or some subset of desired criteria). The alert also may guide personnel as to what to do next, such as checking that patient consent has been received.

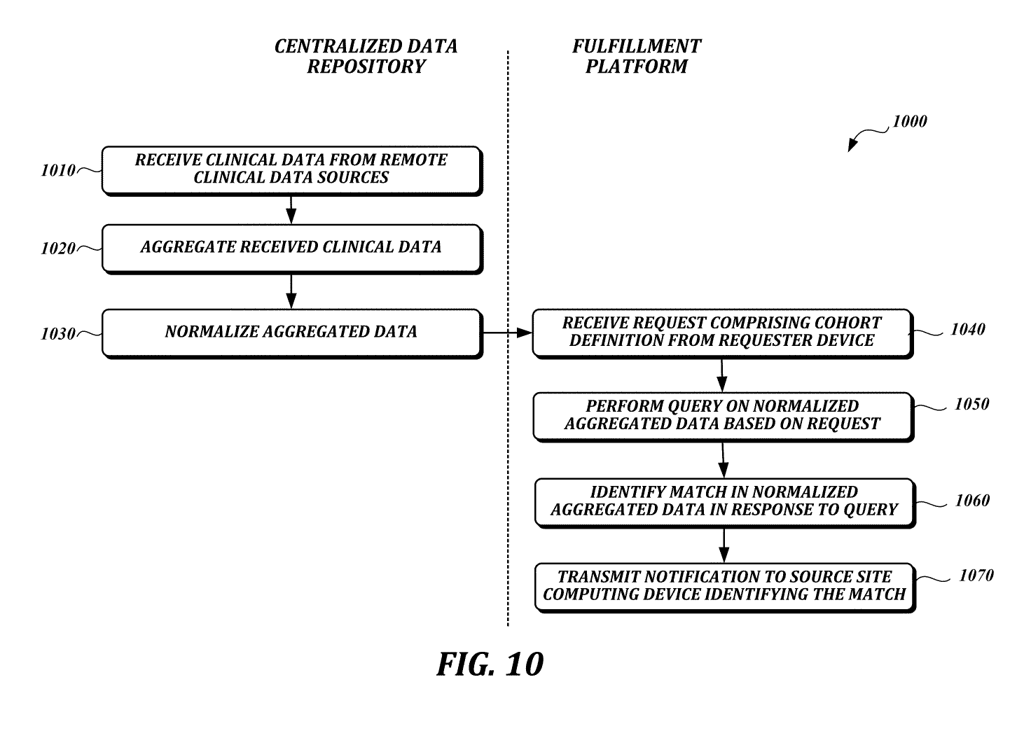

FIG. 10 is a flow chart illustrating a computer-implemented method according to an embodiment of the present disclosure. In the illustrative method 1000 shown in FIG. 10, a computer system (e.g., the computer system 100 shown in FIG. 1) receives (e.g., at the centralized data repository 110) clinical data from remote clinical data sources at step 1010 (e.g., using the interoperability API 112), aggregates the received clinical data at step 1020 (e.g., using known techniques for organizing data from multiple sources in a database), and normalizes the aggregated data at step 1030 (e.g., using known techniques to normalize the aggregated data to common dictionaries). The computer system receives (e.g., at the fulfillment platform 130) a request comprising a cohort definition from a requester computing device (e.g., requester computing device 160) at step 1040, performs a query on the normalized aggregated data based on the request at step 1050 (e.g., using known database querying techniques), identifies a match in the normalized aggregated data in response to the query at step 1060 (e.g., by comparing cohort definition criteria with clinical data associated with available specimens or patients, as described above), and transmits a notification to a source site computing device (e.g., source site computing device 170) at step 1070 (e.g., using notification techniques described above). In at least one embodiment, the source site computing device is a dedicated tablet device, but this is not required. The source site computing device also may be a desktop computer, notebook computer, smart phone, or any other suitable computing device.

In this example, the notification identifies the match at step 1070. The notification may identify the match in different ways, and need not include information about the match in its initial presentation. For example, the notification may include a basic notification window 910, as shown in FIG. 9, while also providing the ability for a user to obtain specification information about the match, such as by providing an interactive element (e.g., notification 920) along with, or as part of, the basic notification window that the user can activate to view additional information about the match. Or, the notification may cause another section of the user interface, such as a separate screen or window, to be updated with additional information about the match. Alternatively, the notification may provide information (e.g., a specimen ID, patient name, etc.) in the initial presentation of the notification that identifies the match. The notification also may include some other type of notification, such as an SMS message or email message containing a link to specific information about the match.

Many alternatives to the illustrative method 1000 are possible. Some functionality that is described as being provided by the computer system 100 may instead be provided by some other computer system, or distributed among multiple computer systems. For example, one computer system may receive, aggregate, and normalize the clinical data, while another computer system may receive a cohort definition, perform a query on the normalized aggregated data, identify a match, and transmit a notification to a source site computing device.

Illustrative Devices and Operating Environments

Unless otherwise specified in the context of specific examples, described techniques and tools may be implemented by any suitable computing device or set of devices.

In any of the described examples, a data store (e.g., a data source or repository described herein) may be hosted, for example, by a database management system (DBMS) to allow a high level of data throughput between the data repository and other components of a described system. The DBMS may also allow the data store to be reliably backed up and to maintain a high level of availability. For example, a data store may be accessed by other system components via a network, such as a private network in the vicinity of the system, a secured transmission channel over the public Internet, a combination of private and public networks, and the like. Instead of or in addition to a DBMS, a data store may include structured data stored as files in a traditional file system. Data stores may reside on computing devices that are part of or separate from components of systems described herein. Separate data stores may be combined into a single data store, or a single data store may be split into two or more separate data stores.

Some of the functionality described herein may be implemented in the context of a client-server relationship. In this context, server devices may include suitable computing devices configured to provide information and/or services described herein. Server devices may include any suitable computing devices, such as dedicated server devices. Server functionality provided by server devices may, in some cases, be provided by software (e.g., virtualized computing instances or application objects) executing on a computing device that is not a dedicated server device. The term “client” can be used to refer to a computing device that obtains information and/or accesses services provided by a server over a communication link. However, the designation of a particular device as a client device does not necessarily require the presence of a server. At various times, a single device may act as a server, a client, or both a server and a client, depending on context and configuration. Actual physical locations of clients and servers are not necessarily important, but the locations can be described as “local” for a client and “remote” for a server to illustrate a common usage scenario in which a client is receiving information provided by a server at a remote location. Alternatively, a peer-to-peer arrangement, or other models, can be used for transfer and processing of data.

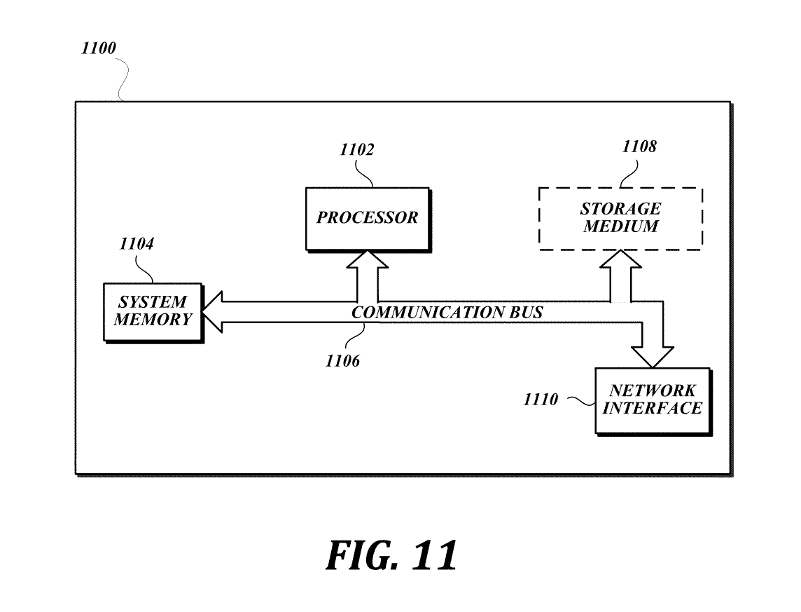

FIG. 11 is a block diagram that illustrates aspects of an illustrative computing device 1100 appropriate for use in accordance with embodiments of the present disclosure. The description below is applicable to servers, personal computers, mobile phones, smart phones, tablet computers, embedded computing devices, and other currently available or yet-to-be-developed devices that may be used in accordance with embodiments of the present disclosure.

In its most basic configuration, the computing device 1100 includes at least one processor 1102 and a system memory 1104 connected by a communication bus 1106. Depending on the exact configuration and type of device, the system memory 1104 may be volatile or nonvolatile memory, such as read only memory (“ROM”), random access memory (“RAM”), EEPROM, flash memory, or other memory technology. Those of ordinary skill in the art and others will recognize that system memory 1104 typically stores data and/or program modules that are immediately accessible to and/or currently being operated on by the processor 1102. In this regard, the processor 1102 may serve as a computational center of the computing device 1100 by supporting the execution of instructions.

As further illustrated in FIG. 11, the computing device 1100 may include a network interface 1110 comprising one or more components for communicating with other devices over a network. Embodiments of the present disclosure may access basic services that utilize the network interface 1110 to perform communications using common network protocols. The network interface 1110 may also include a wireless network interface configured to communicate via one or more wireless communication protocols, such as WiFi, 2G, 3G, 4G, LTE, WiMAX, Bluetooth, and/or the like.

In the illustrative embodiment depicted in FIG. 11, the computing device 1100 also includes a storage medium 1108. However, services may be accessed using a computing device that does not include means for persisting data to a local storage medium. Therefore, the storage medium 1108 depicted in FIG. 11 is optional. In any event, the storage medium 1108 may be volatile or nonvolatile, removable or nonremovable, implemented using any technology capable of storing information such as, but not limited to, a hard drive, solid state drive, CD-ROM, DVD, or other disk storage, magnetic tape, magnetic disk storage, and/or the like.

As used herein, the term “computer-readable medium” includes volatile and nonvolatile and removable and nonremovable media implemented in any method or technology capable of storing information, such as computer-readable instructions, data structures, program modules, or other data. In this regard, the system memory 1104 and storage medium 1108 depicted in FIG. 11 are examples of computer-readable media.

For ease of illustration and because it is not important for an understanding of the claimed subject matter, FIG. 11 does not show some of the typical components of many computing devices. In this regard, the computing device 1100 may include input devices, such as a keyboard, keypad, mouse, trackball, microphone, video camera, touchpad, touchscreen, electronic pen, stylus, and/or the like. Such input devices may be coupled to the computing device 1100 by wired or wireless connections including RF, infrared, serial, parallel, Bluetooth, USB, or other suitable connection protocols using wireless or physical connections.

In any of the described examples, input data can be captured by input devices and processed, transmitted, or stored (e.g., for future processing). The processing may include encoding data streams, which can be subsequently decoded for presentation by output devices. Media data can be captured by multimedia input devices and stored by saving media data streams as files on a computer-readable storage medium (e.g., in memory or persistent storage on a client device, server, administrator device, or some other device). Input devices can be separate from and communicatively coupled to computing device 1100 (e.g., a client device), or can be integral components of the computing device 1100. In some embodiments, multiple input devices may be combined into a single, multifunction input device (e.g., a video camera with an integrated microphone). The computing device 1100 may also include output devices such as a display, speakers, printer, etc. The output devices may include video output devices such as a display or touchscreen. The output devices also may include audio output devices such as external speakers or earphones. The output devices can be separate from and communicatively coupled to the computing device 1100, or can be integral components of the computing device 1100. Input functionality and output functionality may be integrated into the same input/output device (e.g., a touchscreen). Any suitable input device, output device, or combined input/output device either currently known or developed in the future may be used with described systems.

In general, functionality of computing devices described herein may be implemented in computing logic embodied in hardware or software instructions, which can be written in a programming language, such as C, C++, COBOL, JAVA™, PHP, Perl, Python, Ruby, HTML, CSS, JavaScript, VBScript, ASPX, Microsoft .NET™ languages such as C#, and/or the like. Computing logic may be compiled into executable programs or written in interpreted programming languages. Generally, functionality described herein can be implemented as logic modules that can be duplicated to provide greater processing capability, merged with other modules, or divided into sub-modules. The computing logic can be stored in any type of computer-readable medium (e.g., a non-transitory medium such as a memory or storage medium) or computer storage device and be stored on and executed by one or more general-purpose or special-purpose processors, thus creating a special-purpose computing device configured to provide functionality described herein.

### Extensions and Alternatives

Many alternatives to the systems and devices described herein are possible. For example, individual modules or subsystems can be separated into additional modules or subsystems or combined into fewer modules or subsystems. As another example, modules or subsystems can be omitted or supplemented with other modules or subsystems. As another example, functions that are indicated as being performed by a particular device, module, or subsystem may instead be performed by one or more other devices, modules, or subsystems. Although some examples in the present disclosure include descriptions of devices comprising specific hardware components in specific arrangements, techniques and tools described herein can be modified to accommodate different hardware components, combinations, or arrangements. Further, although some examples in the present disclosure include descriptions of specific usage scenarios, techniques and tools described herein can be modified to accommodate different usage scenarios. Functionality that is described as being implemented in software can instead be implemented in hardware, or vice versa.

Many alternatives to the techniques described herein are possible. For example, processing stages in the various techniques can be separated into additional stages or combined into fewer stages. As another example, processing stages in the various techniques can be omitted or supplemented with other techniques or processing stages. As another example, processing stages that are described as occurring in a particular order can instead occur in a different order. As another example, processing stages that are described as being performed in a series of steps may instead be handled in a parallel fashion, with multiple modules or software processes concurrently handling one or more of the illustrated processing stages. As another example, processing stages that are indicated as being performed by a particular device or module may instead be performed by one or more other devices or modules.

Many alternatives to the user interfaces described herein are possible. In practice, the user interfaces described herein may be implemented as separate user interfaces or as different states of the same user interface, and the different states can be presented in response to different events, e.g., user input events. The user interfaces can be customized for different devices, input and output capabilities, and the like. For example, the user interfaces can be presented in different ways depending on display size, display orientation, whether the device is a mobile device, etc. The information and user interface elements shown in the user interfaces can be modified, supplemented, or replaced with other elements in various possible implementations. For example, various combinations of graphical user interface elements including text boxes, sliders, drop-down menus, radio buttons, soft buttons, etc., or any other user interface elements, including hardware elements such as buttons, switches, scroll wheels, microphones, cameras, etc., may be used to accept user input in various forms. As another example, the user interface elements that are used in a particular implementation or configuration may depend on whether a device has particular input and/or output capabilities (e.g., a touchscreen). Information and user interface elements can be presented in different spatial, logical, and temporal arrangements in various possible implementations. For example, information or user interface elements depicted as being presented simultaneously on a single page or tab may also be presented at different times, on different pages or tabs, etc. As another example, some information or user interface elements may be presented conditionally depending on previous input, user preferences, or the like.

The principles, representative embodiments, and modes of operation of the present disclosure have been described in the foregoing description. However, aspects of the present disclosure which are intended to be protected are not to be construed as limited to the particular embodiments disclosed. Further, the embodiments described herein are to be regarded as illustrative rather than restrictive. It will be appreciated that variations and changes may be made by others, and equivalents employed, without departing from the spirit of the present disclosure. Accordingly, it is expressly intended that all such variations, changes, and equivalents fall within the spirit and scope of the claimed subject matter.

The embodiments of the invention in which an exclusive property or privilege is claimed are defined as follows:

1. A computer system comprising one or more computers programmed to:
host a centralized data repository and a biological specimen fulfillment platform;
wherein the centralized data repository is configured to:
receive clinical data corresponding to a plurality of patients from a plurality of remote clinical data sources;
aggregate the received clinical data; and
normalize the aggregated clinical data; and
wherein the biological specimen fulfillment platform is configured to:
receive a biological specimen request from a requester computing device, wherein the request comprises a cohort definition;
perform a query on the aggregated clinical data based on the request;
identify a match in the aggregated clinical data in response to the query; and
transmit a notification to a source site computing device for the identified match, wherein the notification identifies a matching biological specimen.

2. The computer system of claim 1, wherein the source site computing device is a dedicated tablet device.

3. The computer system of claim 1, wherein the source site computing device comprises a digital camera and is programmed to present a user interface for capturing an image of a biological specimen container using the digital camera.

4. The computer system of claim 1, wherein the biological specimen fulfillment platform is further configured to provide a source site portal accessible by the source site computing device.

5. The computer system of claim 1, wherein the biological specimen fulfillment platform is further configured to provide a requester portal accessible by the requester computing device.

6. The computer system of claim 1, wherein the match is identified based at least in part on a comparison of the cohort definition with a patient profile.

7. The computer system of claim 1, wherein the received clinical data is pre-filtered based on patient consent.

8. The computer system of claim 1, wherein the notification comprises fulfillment instructions.

9. A computer system comprising one or more computers programmed to:
host a central clinical data repository and a fulfillment platform;
wherein the central clinical data repository is configured to:
receive patient data corresponding to a plurality of patients from a plurality of remote clinical data sources; and
aggregate the received patient data;
normalize the aggregated patient data; and
wherein the fulfillment platform is configured to:
receive a request from a requester computing device, wherein the request comprises a cohort definition;
perform a query on the aggregated patient data based on the request;
identify a match in the aggregated patient data in response to the query; and
transmit a notification to a source site computing device for the identified match, wherein the notification identifies a patient that matches the cohort definition.

10. The computer system of claim 9, wherein the source site computing device is a dedicated tablet device.

11. The computer system of claim 9, wherein the fulfillment platform is further configured to provide a source site portal accessible by the source site computing device.

12. The computer system of claim 9, wherein the fulfillment platform is further configured to provide a requester portal accessible by the requester computing device.

13. The computer system of claim 9, wherein the match is identified based at least in part on a comparison of the cohort definition with a patient profile.

14. The computer system of claim 9, wherein the received patient data is pre-filtered based on patient consent.

15. A computer-implemented method comprising:
receiving clinical data corresponding to a plurality of patients from a plurality of remote clinical data sources;
aggregating the received clinical data;
normalizing the aggregated clinical data;
receiving a request from a requester computing device, wherein the request comprises a cohort definition;
performing a query on the aggregated clinical data based on the request;
identifying a match in the aggregated clinical data in response to the query; and
transmitting a notification to a source site computing device, wherein the notification identifies the match.

16. The method of claim 15, further comprising providing a source site portal accessible by the source site computing device.

17. The method of claim 15, further comprising providing a requester portal accessible by the requester computing device.

18. The method of claim 15, wherein the match is identified based at least in part on a comparison of the cohort definition with a patient profile.

19. The method of claim 15, wherein the request is for biological specimens.

20. The method of claim 15, wherein the request is for patients.
